(19) United States
(12) Patent Application Publication
(10) Pub. No.: US 2011/0273691 A1
(43) Pub. Date: Nov. 10, 2011

(54) RADIATION SOURCE, METHOD OF CONTROLLING A RADIATION SOURCE, LITHOGRAPHIC APPARATUS, AND METHOD FOR MANUFACTURING A DEVICE

(75) Inventors: Erik Petrus BUURMAN, Veldhoven (NL); Nicolaas Antonius Allegondu Johannes VAN ASTEN, Breda (NL); Hermanus Johannes Maria KREUWEL, Schijndel (NL)

(73) Assignee: ASML Netherlands B.V., Veldhoven (NL)

(21) Appl. No.: 13/101,795

(22) Filed: May 5, 2011

Related U.S. Application Data
(60) Provisional application No. 61/331,963, filed on May 6, 2010.

(51) Int. Cl. G03B 27/54; H05G 2/00

(52) U.S. Cl. 355/67; 250/504 R; 355/77

(57) ABSTRACT

An EUV radiation source in the form of a plasma is focused at a virtual source point so as to pass through an exit aperture of a source collector module in an EUV lithographic apparatus. Plasma position is controlled in three directions, X, Y and Z using monitoring signals. By exploiting the photoacoustic effect, the monitoring is accomplished in a non-intrusive manner using acoustic sensors coupled to material of a cone which surrounds the exit aperture. Different angular positions of the radiation beam can be deduced by discriminating signals from the different sensors on the basis of relative arrival time or phase, and/or by comparing the amplitude/intensity of the signals. A sequencer function can be used to introduce a sequence of deliberate offsets in the beam position. This allows acoustic signals to be generated and detected for measurement purposes, when the beam would otherwise not impinge on the material.

### CROSS-REFERENCE TO RELATED APPLICATIONS

This application claims the benefit of priority from U.S. Provisional Patent Application No. 61/331,963, filed May 6, 2010, the entire content of which is incorporated herein by reference.

### FIELD

The present invention relates to a radiation source apparatus, a method of controlling a radiation source, and to lithographic apparatus and a method for manufacturing a device. The invention is particularly applicable to the control of radiation source apparatus for extreme ultraviolet (EUV) radiation.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. comprising part of one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned.

Lithography is widely recognized as one of the key steps in the manufacture of ICs and other devices and/or structures. However, as the dimensions of features made using lithography become smaller, lithography is becoming a more critical factor for enabling miniature IC or other devices and/or structures to be manufactured.

A theoretical estimate of the limits of pattern printing can be given by the Rayleigh criterion for resolution as shown in equation (1):

$$CD = {k}_{1} * \frac{λ}{NA} \qquad ( 1 )$$

where λ is the wavelength of the radiation used, NA is the numerical aperture of the projection system used to print the pattern, k1 is a process dependent adjustment factor, also called the Rayleigh constant, and CD is the feature size (or critical dimension) of the printed feature. It follows from equation (1) that reduction of the minimum printable size of features can be obtained in three ways: by shortening the exposure wavelength λ, by increasing the numerical aperture NA or by decreasing the value of k1.

In order to shorten the exposure wavelength and, thus, reduce the minimum printable size, it has been proposed to use an extreme ultraviolet (EUV) radiation source. EUV radiation is electromagnetic radiation having a wavelength within the range of 5-20 nm, for example within the range of 13-14 nm. It has further been proposed that EUV radiation with a wavelength of less than 10 nm could be used, for example within the range of 5-10 nm such as 6.7 nm or 6.8 nm. Such radiation is termed extreme ultraviolet radiation or soft x-ray radiation. Possible sources include, for example, laser-produced plasma (LPP) sources, discharge plasma (DPP) sources, or sources based on synchrotron radiation provided by an electron storage ring.

An example of current progress in the development of LPP sources for EUV lithography is described in the paper “High power LPP EUV source system development status” by Benjamin Szu-Min Lin, David Brandt, Nigel Farrar, SPIE Proceedings Vol. 7520, Lithography Asia 2009, December 2009 (SPIE Digital Library reference DOI: 10.1117/12.839488).

In a lithographic apparatus, or any optical apparatus using a beam of EUV radiation, the source apparatus will typically be contained within its own vacuum housing, while a small exit aperture is provided to couple the beam into an optical system where the radiation is to be used. Maintaining the beam at the aperture and ensuring that it remains there influences the performance of the optical system. The manner of controlling the beam focus and alignment is not material to embodiments of the present invention. It may be done by moving the source (e.g. plasma) while optical elements remain fixed, or it may be done by moving optical elements, or by a combination of techniques.

United States Patent Application Publication No. US2005/0274897A1 (and equivalent International Patent Application Publication No. WO2004/031854A2, assigned to Carl Zeiss & ASML) describes the provision and use of optical sensors in the illuminator of an EUV lithographic apparatus. By providing sensors in four quadrants at one or more locations along the beam path, the proposal is to obtain measurements intensity and alignment (asymmetry) properties of the beam. These measurements are used for control of the lithographic exposure operation, and optionally for control of the source apparatus as well.

Sensors in the apparatus of US2005/0274897A1 are located away from the aperture, and ‘downstream’ of the aperture. United States Patent Application Publication No. US2009/0015814A1 (assigned to Carl Zeiss) proposes alternative forms of sensor based on doped optical fibers, that can be placed in the beam at various desired locations, including very close to the aperture. These sensors can also be in quadrant arrangements, and can be used for the same purposes as described in US2005/0274897A1.

### SUMMARY

Embodiments of the invention are concerned with providing alternative sensing arrangements for measuring alignment and other properties of an EUV beam. Embodiments of the invention aim to provide real-time measurements of beam alignment in the vicinity of an aperture through which the beam of EUV radiation exits a radiation source apparatus such as the source collector module in an EUV lithographic apparatus. One concern is that any significant portion of the beam impinging on the material surrounding this source exit aperture is liable to cause thermal damage to the material. To allow for such damage may increase the cost of building and/or operating the apparatus. Since there are typically large vacuum chambers, water cooling ducts and the like combined in a complex and expensive apparatus, failures induced by such damage may be dangerous and even catastrophic.

Embodiments of the invention aim to provide novel techniques for measuring and controlling the alignment of a radiation beam passing though an aperture. Embodiments of the invention aim in particular to detect directly and quickly whether EUV radiation is impinging on material adjacent the beam path.

According to an aspect of the invention, there is provided a radiation source apparatus that includes a radiation source configured to emit electromagnetic radiation at an EUV wavelength; a radiation collector configured to receive the emitted radiation and form a beam of EUV radiation focused at a virtual source point; an exit aperture positioned in the vicinity of the virtual source point to deliver the EUV radiation from an internal environment of the radiation source apparatus to an optical system where the EUV radiation is to be used; an acoustic sensor coupled to material located adjacent the radiation beam at or near the exit aperture; and a processor configured to process signals received from the acoustic sensor so as to detect when part of the radiation beam impinges on the material.

Embodiments of the invention exploit the so-called photoacoustic effect, whereby localized and transient heating caused by a radiation pulse will cause a sound wave to be induced in the material.

According to an aspect of the invention, there is provided a method of controlling a radiation source apparatus. The method includes emitting electromagnetic radiation at an EUV wavelength with a radiation source; receiving the emitted radiation and forming a beam of EUV radiation focused at a virtual source point with a radiation collector; delivering the EUV radiation from an internal environment of the radiation source apparatus to an optical system where the EUV radiation is to be used through an exit aperture positioned in the vicinity of the virtual source point; detecting an acoustic signal in material located adjacent the radiation beam at or near the exit aperture; and processing the acoustic signal so as to detect when part of the radiation beam impinges on the material.

According to an aspect of the invention, there is provided a lithographic apparatus comprising a source collector module comprising radiation source apparatus according to the invention as set forth above, an illuminator module for receiving the beam of EUV radiation from the exit aperture of the radiation source apparatus and for conditioning the beam to illuminate a patterning device, and a projection system for producing an image of the illuminated patterning device on a substrate, in order to transfer a pattern from the patterning device to the substrate by EUV lithography.

According to an aspect of the invention, there is provided a method of manufacturing a device, for example a semiconductor device, wherein as part of the method an image of a patterning device is projected using EUV radiation onto a substrate, in order to transfer a device pattern from the patterning device to the substrate, wherein the EUV radiation is provided by a radiation source apparatus controlled by a method according to the invention as set forth above.

These aspects of the invention and various optional features and implementations thereof will be understood by the skilled reader from the description of examples which follows.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts schematically a lithographic apparatus according to an embodiment of the invention;

FIG. 2 is a more detailed view of the apparatus of FIG. 1;

FIG. 3 illustrates an embodiment of an EUV radiation source usable in the apparatus of FIGS. 1 and 2;

FIG. 4 shows an embodiment of a control system for an EUV radiation source;

FIG. 5 is a schematic cross-section of an embodiment of a sensing and control apparatus based on photoacoustic effect;

FIG. 6 illustrates principles of operation of the apparatus of FIG. 5, when a radiation beam is not centered in an exit aperture of an EUV radiation source apparatus;

FIGS. 7 and 8 illustrate the operation of servo loops in the apparatus of FIG. 5, for controlling plasma position in Y and X directions respectively; and

FIG. 9 illustrates a further example of a novel sensing an control apparatus, including servo loops for controlling plasma position in X, Y and Z (focus) directions.

### DETAILED DESCRIPTION

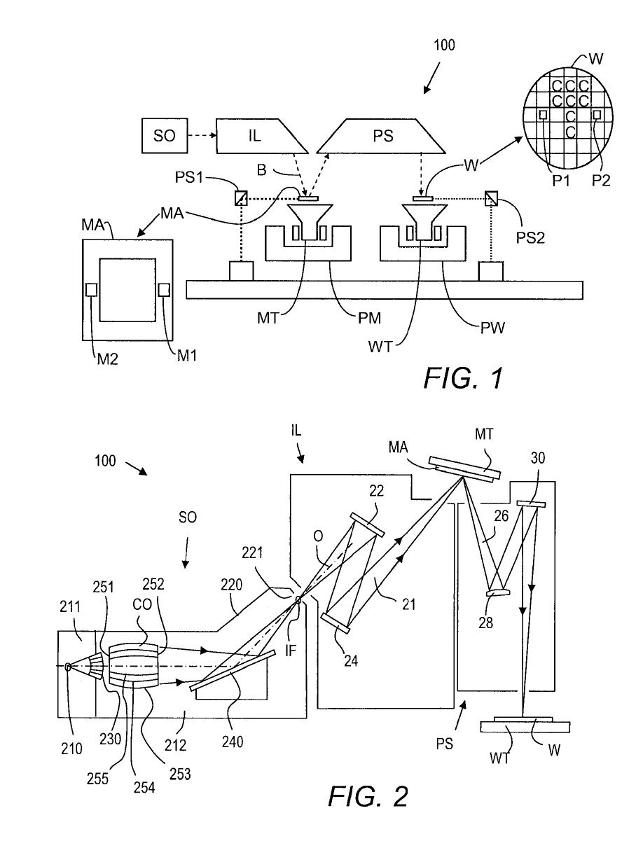

FIG. 1 schematically depicts a lithographic apparatus 100 including a source collector module SO which forms a radiation source apparatus according to one embodiment of the invention. The apparatus comprises: an illumination system (illuminator) IL configured to condition a radiation beam B (e.g. EUV radiation); a support structure (e.g. a mask table) MT constructed to support a patterning device (e.g. a mask or a reticle) MA and connected to a first positioner PM configured to accurately position the patterning device; a substrate table (e.g. a wafer table) WT constructed to hold a substrate (e.g. a resist-coated wafer) W and connected to a second positioner PW configured to accurately position the substrate; and a projection system (e.g. a reflective projection system) PS configured to project a pattern imparted to the radiation beam B by patterning device MA onto a target portion C (e.g. comprising one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure MT holds the patterning device MA in a manner that depends on the orientation of the patterning device, the design of the lithographic apparatus, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system.

The term “patterning device” should be broadly interpreted as referring to any device that can be used to impart a radiation beam with a pattern in its cross-section such as to create a pattern in a target portion of the substrate. The pattern imparted to the radiation beam may correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The projection system, like the illumination system, may include various types of optical components, such as refractive, reflective, magnetic, electromagnetic, electrostatic or other types of optical components, or any combination thereof, as appropriate for the exposure radiation being used, or for other factors such as the use of a vacuum. It may be desired to use a vacuum for EUV radiation since other gases may absorb too much radiation. A vacuum environment may therefore be provided to the whole beam path with the aid of a vacuum wall and vacuum pumps.

As here depicted, the apparatus is of a reflective type (e.g. employing a reflective mask).

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

Referring to FIG. 1, the illuminator IL receives an extreme ultra violet radiation beam from the source collector module SO. Methods to produce EUV light include, but are not necessarily limited to, converting a material into a plasma state that has at least one element, e.g., xenon, lithium or tin, with one or more emission lines in the EUV range. In one such method, often termed laser produced plasma (“LPP”) the desired plasma can be produced by irradiating a fuel, such as a droplet, stream or cluster of material having the required line-emitting element, with a laser beam. The source collector module SO may be part of an EUV radiation system including a laser, not shown in FIG. 1, for providing the laser beam exciting the fuel. The resulting plasma emits output radiation, e.g., EUV radiation, which is collected using a radiation collector, disposed in the source collector module. The laser and the source collector module may be separate entities, for example when a CO₂ laser is used to provide the laser beam for fuel excitation.

In such cases, the laser is not considered to form part of the lithographic apparatus and the radiation beam is passed from the laser to the source collector module with the aid of a beam delivery system comprising, for example, suitable directing mirrors and/or a beam expander. In other cases the source may be an integral part of the source collector module, for example when the source is a discharge produced plasma EUV generator, often termed as a DPP source.

The illuminator IL may comprise an adjuster for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may comprise various other components, such as facetted field and pupil mirror devices. The illuminator may be used to condition the radiation beam, to have a desired uniformity and intensity distribution in its cross-section.

The radiation beam B is incident on the patterning device (e.g., mask) MA, which is held on the support structure (e.g., mask table) MT, and is patterned by the patterning device. After being reflected from the patterning device (e.g. mask) MA, the radiation beam B passes through the projection system PS, which focuses the beam onto a target portion C of the substrate W. With the aid of the second positioner PW and position sensor PS2 (e.g. an interferometric device, linear encoder or capacitive sensor), the substrate table WT can be moved accurately, e.g. so as to position different target portions C in the path of the radiation beam B. Similarly, the first positioner PM and another position sensor PS1 can be used to accurately position the patterning device (e.g. mask) MA with respect to the path of the radiation beam B. Patterning device (e.g. mask) MA and substrate W may be aligned using mask alignment marks M1, M2 and substrate alignment marks P1, P2.

The depicted apparatus could be used in at least one of the following modes:

1. In step mode, the support structure (e.g. mask table) MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed.

2. In scan mode, the support structure (e.g. mask table) MT and the substrate table WT are scanned synchronously while a pattern imparted to the radiation beam is projected onto a target portion C (i.e. a single dynamic exposure). The velocity and direction of the substrate table WT relative to the support structure (e.g. mask table) MT may be determined by the (de-) magnification and image reversal characteristics of the projection system PS.

3. In another mode, the support structure (e.g. mask table) MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

FIG. 2 shows the apparatus 100 in more detail, including the source collector module SO, the illumination system IL, and the projection system PS. The source collector module SO is constructed and arranged such that a vacuum environment can be maintained in an enclosing structure 220 of the source collector module SO. An EUV radiation emitting plasma 210 may be formed by a discharge produced plasma source. EUV radiation may be produced by a gas or vapor, for example Xe gas, Li vapor or Sn vapor in which the very hot plasma 210 is created to emit radiation in the EUV range of the electromagnetic spectrum. The very hot plasma 210 is created by, for example, an electrical discharge causing an at least partially ionized plasma. Partial pressures of, for example, 10 Pa of Xe, Li, Sn vapor or any other suitable gas or vapor may be desired for efficient generation of the radiation. In an embodiment, a plasma of excited tin (Sn) is provided to produce EUV radiation.

The radiation emitted by the hot plasma 210 is passed from a source chamber 211 into a collector chamber 212 via an optional gas barrier or contaminant trap 230 (in some cases also referred to as contaminant barrier or foil trap) which is positioned in or behind an opening in source chamber 211. The contaminant trap 230 may include a channel structure. Contaminant trap 230 may also include a gas barrier or a combination of a gas barrier and a channel structure. The contaminant trap or contaminant barrier 230 further indicated herein at least includes a channel structure, as known in the art.

The collector chamber 212 may include a radiation collector CO which may be a so-called grazing incidence collector. Radiation collector CO has an upstream radiation collector side 251 and a downstream radiation collector side 252. Radiation that traverses collector CO can be reflected off a grating spectral purity filter 240 to be focused in a virtual source point IF. The virtual source point IF is commonly referred to as the intermediate focus, and the source collector module is arranged such that the intermediate focus IF is located at or near an aperture 221 in the enclosing structure 220. The virtual source point IF is an image of the radiation emitting plasma 210.

Subsequently the radiation traverses the illumination system IL, which may include a facetted field mirror device 22 and a facetted pupil mirror device 24 arranged to provide a desired angular distribution of the radiation beam 21, at the patterning device MA, as well as a desired uniformity of radiation intensity at the patterning device MA. Upon reflection of the beam of radiation 21 at the patterning device MA, held by the support structure MT, a patterned beam 26 is formed and the patterned beam 26 is imaged by the projection system PS via reflective elements 28, 30 onto a substrate W held by the wafer stage or substrate table WT.

More elements than shown may generally be present in illumination optics unit IL and projection system PS. The grating spectral filter 240 may optionally be present, depending upon the type of lithographic apparatus. Further, there may be more mirrors present than those shown in the Figures, for example there may be 1-6 additional reflective elements present in the projection system PS than shown in FIG. 2.

Collector CO, as illustrated in FIG. 2, is depicted as a nested collector with grazing incidence reflectors 253, 254 and 255, just as an example of a collector (or collector mirror). The grazing incidence reflectors 253, 254 and 255 are disposed axially symmetric around an optical axis O and a collector CO of this type is preferably used in combination with a discharge produced plasma source, often called a DPP source.

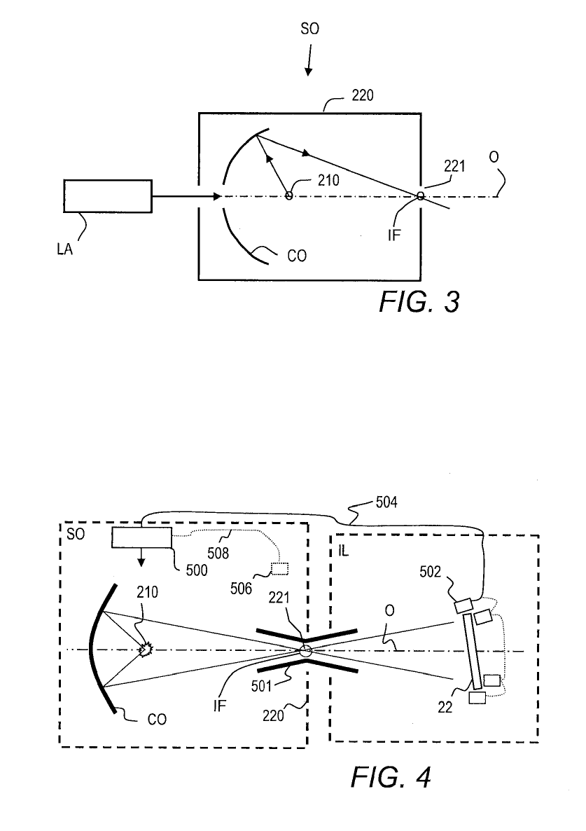

Alternatively, the source collector module SO may be part of an LPP radiation system as shown in FIG. 3. A laser LA is arranged to deposit laser energy into a fuel, such as xenon (Xe), tin (Sn) or lithium (Li), creating the highly ionized plasma 210 with electron temperatures of several 10's of eV. The energetic radiation generated during de-excitation and recombination of these ions is emitted from the plasma, collected by a near normal incidence collector CO and focused onto the aperture 221. The plasma 210 and the aperture 221 are located at first and second focal points of collector CO, respectively.

Other embodiments of the radiation source apparatus are possible. For example, a spectral purity filter (SPF) of a transmissive type may be used instead of the reflective grating illustrated in FIG. 2. The radiation from collector CO in that case follows a straight path from the collector to the intermediate focus (virtual source point IF). The spectral purity filter may be positioned near the virtual source point or at any point between the collector and the virtual source point. The filter can be placed at other locations in the radiation path, for example downstream of the virtual source point IF. Multiple filters can be deployed. As in the previous examples, the collector CO may be of the grazing incidence type (FIG. 2) or of the direct reflector type (FIG. 3).

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Embodiments described herein are generally directed to techniques for monitoring the alignment of a radiation beam with an exit aperture of a radiation source apparatus, for example, with the virtual source point IF is aligned with the aperture 221, at the exit from the EUV radiation source module of an EUV lithographic apparatus. In systems based on DPP or LPP sources, control of alignment is generally achieved by controlling the location of the plasma 210, rather than by moving the collector optics. In US2005/0274897A1, mentioned above, the beam alignment is partly controlled by manipulation of a reflective-type spectral purity filter 240. The exact manner of control, and indeed the nature of the source itself, are not material to the present invention.

FIG. 4 is a schematic illustration of the monitoring and control mechanisms associated with IF alignment in an existing EUV lithographic apparatus. An LPP source collector module SO with a normal incidence type of collector CO is presented, only as one example. Reference signs for various components are used with the same meanings as in FIGS. 2-3, described above. The collector optics, the exit aperture 221 and the illuminator IL are aligned accurately during a set-up process, so that aperture 221 is located at the second focal point of collector optic. However, the exact location of the virtual source point IF formed by the EUV radiation at the exit of the source optics is dependent on the exact location of the plasma 210 or other source of radiation, relative to the first focal point of the collector optics. Whether the source is a stream of fuel or a discharge, to fix this location accurately enough to maintain sufficient alignment generally desires active monitoring and control.

For this purpose, a control module 500 in this example controls the location of the plasma 210 (the source of the EUV radiation), by controlling the injection of the fuel, and also for example the timing of energizing pulses from laser LA (not shown in FIG. 4). In a typical example, energizing pulses are delivered at a rate of 50 kHz (period 20 μs), and in bursts lasting from about 20 ms to about 20 seconds. The duration of each energizing pulse may be around 1 μs, while the resulting EUV radiation pulse may last around 2 μs. By appropriate control, it is maintained that the EUV radiation beam may be focused by collector CO precisely on the aperture 221. If this is not achieved, all or part of the beam will impinge upon surrounding material of the enclosing structure 220, specifically in this example an IF cone 501.

In accordance with current practice, control module 500 is supplied with monitoring data from one or more arrays of sensors 502 which provide a first feedback path for information as to the location of the plasma. The sensors may be of various types, for example as described in US2005/0274897A1, mentioned in the introduction. The sensors may be located at more than one position along the radiation beam path. Here they are shown located around and/or behind the field mirror device 22, purely for the sake of example. The sensor signals just described can be used for control of the optical systems of the illuminator IL and projection system PS. They can also be used, via feedback path 504, to assist the control module 500 of the source collector module SO to adjust the position of the EUV source. The sensor signals can be processed for example to determine the observed location of the virtual source IF, and this is extrapolated to determine, indirectly, the location of the EUV source. If the virtual source location drifts, the sensor signals indicate asymmetry of the detected illumination, onto the IF cone 501, corrections are applied by control module 500 to re-center the beam in the aperture 221.

Rather than rely entirely on the signals from the illuminator sensors 502, additional sensors 506 and feedback paths 508 will generally be provided in the source collector module SO itself, to provide for more rapid, direct and self-contained control of the radiation source. Sensors 506 may include one or more cameras, for example, monitoring the location of the plasma.

The existing arrangements just described may have certain drawbacks. Since the illuminator IL where the first sensors 502 are located is in a separate vacuum vessel from the source collector module, and these modules may be manufactured quite separately from one another, interfacing and set-up issues are multiplied; testing cannot be completed until the two sub-systems are brought together. Further, measurement of alignment using sensors 506 may necessitate the provision of the second monitoring and feedback path, which adds to expense and cannot necessarily provide information in real time. The location of complex and sensitive modules sensor 506 within the delicate yet hostile environment of the source collector module may impose costly specifications, and risks contamination through outgassing, service outages and so forth. Even using the optical sensors of US2009/0015814A1, mentioned above, would involve penetrating the enclosing structure 220.

As described above, the consequences of not focusing the beam tightly and centering it in the aperture may both negatively impact the performance of the apparatus and potentially damage its components. They may be damaging to the lithographic apparatus as a whole, for example if the material of IF cone 501 overheats to cause cracking or melting. The aperture 221 is typically only a few millimeters in diameter, for example between 4 and 8 mm. The power in the focused radiation beam is substantial and capable of causing damage very quickly to any components in its path. Fatigue in the material surrounding the aperture may be exacerbated by the fact that the stray radiation, and therefore the heating, is not continuous but rather pulsed, and in bursts. On the other hand, the inventors have recognized that the pulsed nature of the radiation creates an opportunity to obtain direct, relatively instantaneous monitoring of radiation hitting the material of the IF cone 501.

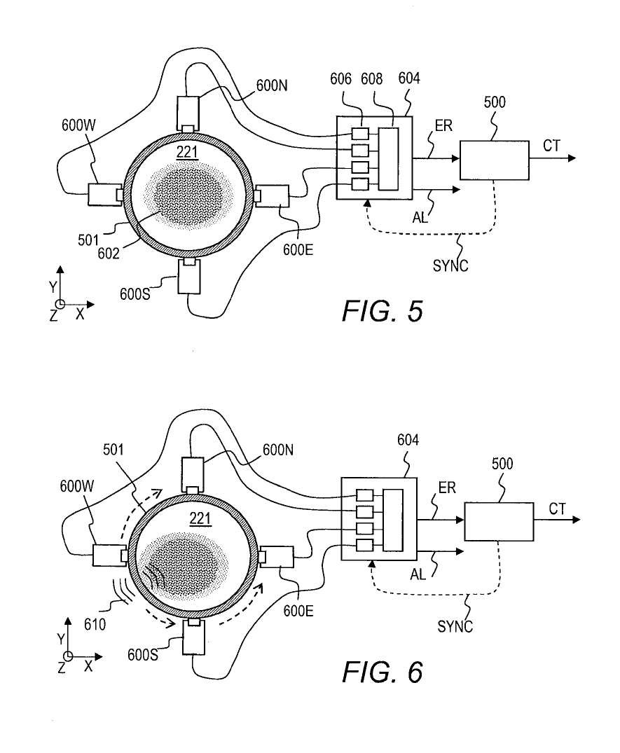

FIG. 5 illustrates a novel monitoring and control system for a EUV radiation source apparatus, based on the so-called photoacoustic effect. This effect is a phenomenon whereby transient heat input to a metal or other material causes acoustic energy (sound waves) to be released and travel through the material. Sounds travels well and quickly through the material of IF cone 501, and the apparatus illustrated includes an array of acoustic sensors (microphones) 600N, 600E, 600S and 600W, mounted on the exterior of the IF cone 501, at an axial position at or near the location of the aperture 221. In the example illustrated, four sensors 600N, 600E, 600S and 600W are located in respective quadrants, but other arrangements of a single sensor or multiple sensors can also be envisaged. The sensors may be piezoelectric sensors, for example. They can be very compact and robust; they need not enter the special environment within the source vessel.

For ease of description and understanding, the suffixes of the labels of the four sensors 600N etc. are labeled with points of the compass north, east, south and west. The beam of EUV radiation, which in FIG. 5 is shown in radial cross-section and perfectly centered in the aperture 221, is labeled 602. The diagram is labeled also with axes X (horizontal) and Y (vertical) in directions transverse to the beam 602, while an axis Z is aligned with the beam and the optical axis O (into the drawing). These axes may correspond with similarly named axes of the source collector module SO and/or illuminator IL, or they may be entirely local to the monitoring and control system which is the subject of the present description. In this example, for simplicity, the north and south sensors are arranged on opposite sides of the aperture 221 in the Y direction, while the east and west sensors are arranged on opposite sides of the aperture in the X direction.

As might be expected, the intensity profile across the beam 602 is most intense at the core of the beam, and decreases with a certain distribution (e.g. Gaussian), indicated in this diagram by a lighter shaded periphery. The system may be designed so that no detectable EUV radiation impinges on the surrounding material when the beam is correctly focused and aligned, or it may be that a small amount will be detected at all times. Such choices inevitably involve engineering choices based on compromises between, for example, the desire not to obstruct the beam, and the desire to isolate the source and illuminator environments from one another as much as possible.

Each sensor 600N etc. is connected to a detection and analysis module 604. The form of this module may be varied freely in the implementation. For the sake of example there are shown pre-processors 606 for the individual sensors and an analyzer 608 for processing the results together. Control module 500 in turn provides a timing reference SYNC to module 604, for use in synchronizing the detection and analysis operations with the energizing pulses applied to plasma source. The module 600 in this example provides error feedback signals ER to source control module 500. Module 500 provides control signals CT to control the position of plasma 210 in X, Y and/or Z directions, thereby completing a closed loop control system (servo loop). An alarm signal AL is also provided, though this could equally be output by the plasma control module 500 itself.

The detection and analysis of sensor signals can be made quite sophisticated, in ways which will be described further below. For the moment, only the basic principles of operation will be described.

In the situation of FIG. 5, no pulsed EUV radiation impinges on the material of IF cone 501, no acoustic signal sensed by sensors 600N etc., and module 604 generates zero error signal ER, and no alarm signal. Controller 500 maintains plasma 210 in a constant position. In the situation of FIG. 6, however, the beam 602 has moved away from its ideal central position to a ‘south west’ position, in which at least the peripheral rays are impinging on the cone 501. The pulsed heating effect which results gives rise to a source 610 of acoustic energy at the same frequency as the EUV pulses. This acoustic energy travels as sound waves through the cone material, to be detected by one or more of the sensors 600N etc. Module 604 outputs feedback error signal ER and/or alarm signal AL, as appropriate. Compared with the known techniques, described above with reference to FIG. 4, the speed of detection using acoustic sensors is practically instantaneous. Feedback error can be provided on the time scale of individual pulses, allowing correction of error with a feedback response time much shorter than the duration of even the shortest burst. As a result, the number of pulses impinging on the material before the beam is corrected is very small, and hence the damaging heating effects can be minimized, compared with known monitoring techniques.

For closed loop (servo) control purposes, of course, it is desirable for the error signals ER to indicate the direction of the error. (If only an alarm signal is desired, the sensors and module 604 need not discriminate direction). Accordingly, in this example, module 604 uses a combination or comparison of the signals from the north, east, south and west sensors to discriminate between alignment errors in the north south (Y) and east-west (X) directions. Discrimination can be on the basis of (i) relative sound amplitude or intensity at each sensor (ii) differences between the arrival times of sounds at each sensor, or (iii) a combination of amplitude and timing. As sound travels from the source 610 around (and along) the cone 501, it is naturally both attenuated and delayed. With regard to amplitude (or intensity) discrimination, the sensor closest in angular position to the source of sound energy 610 will be expected to output the strongest signal to module 604. The amplitude or intensity of the signals from the north, east, south and west sensors will be referred to as A(N), A(E), A(S), and A(W) respectively. In the situation illustrated in FIG. 6, therefore, the strength of acoustic signals will rank A(W)>A(S)>A(N)>A(E). These values can be processed by analyzer 608 of module 604 in a number of ways. The preferred way will depend on signal and noise levels expected, and also on the kinds of outputs needed for the servo control loops implemented by control module 500 on the basis of the delivered error signals ER.

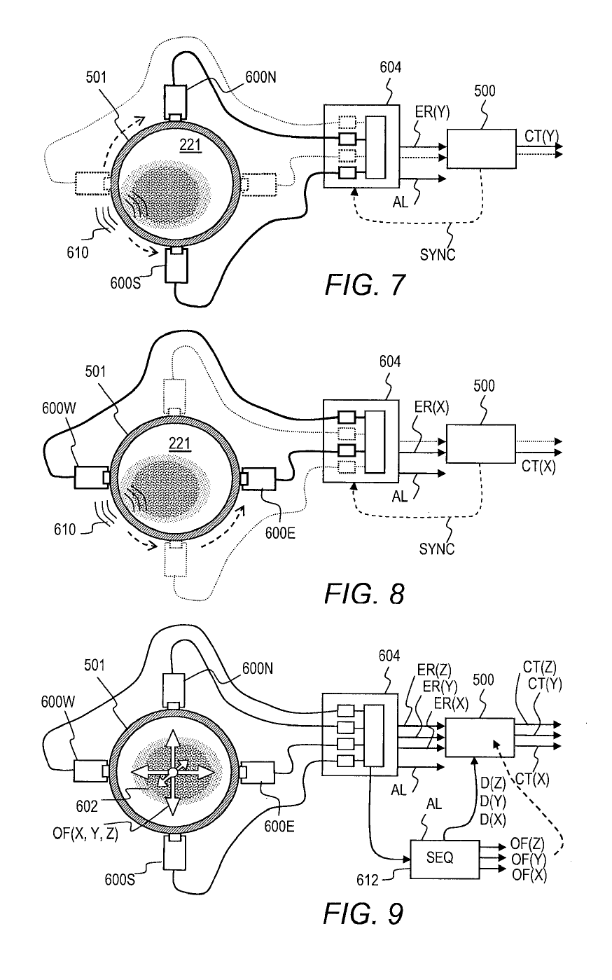

Referring to FIGS. 7 and 8, it may be that plasma 210 is controlled in X and Y directions by separate servo loops. In FIG. 7, the components and signal paths relevant to the Y servo loop are highlighted in bold lines, while other components are shown dotted. Module 604 generates a Y component error signal ER(Y) and control module 500 generates a Y component control signal CT(Y). Only the north and south sensor signals are processed for the Y servo loop. If A(S)>A(N) as shown, signals ER(Y) and CT(Y) are such that a correction is made in the Y servo loop to move the beam ‘northward’. The servo loop will continue to operate in this way until beam 602 it is again centered in the aperture (at least with regard to the Y direction). If it were A(N)>A(S), a correction would be made to move the beam southward, again to re-center it.

Similarly, in FIG. 8, the components and signal paths relevant to the X servo loop are highlighted in bold lines, while other components are shown dotted. Module 604 generates an X component error signal ER(X) and control module 500 generates an X component control signal CT(X). Only the east and west sensor signals are processed for the X servo loop. If A(W)>A(E) as shown, signals ER(X) and CT(X) are such that a correction is made in the X servo loop to move the beam eastwards, that is back towards the center. If it were A(E)>A(W), a correction would be made to move the beam westward.

With the X and Y servo loops operating in parallel, any transverse deviation of the beam can be corrected so that it returns to the center of the aperture 221(or at least until no detectable acoustic energy is generated in the material surrounding the aperture).

With regard to time discrimination, the sensor closest in angular position to the source of sound energy 610 will be expected to report a pulse of sound earlier than the other sensors. In typical metal materials, the speed of sound will be 6000-7000 ms⁻¹, so that a distance of a few millimeters can be resolved by analyzing delays on the order of a microsecond. In the situation illustrated, the arrival sequence of the acoustic signals will occur in the order west, south, north then east. These delays can be processed by analyzer 608 in a number of ways. Again, a simple example is to process the signals in orthogonal pairs north-south and east-west, to generate Y and X error signals for use in Y and X servo loops, as shown already in FIGS. 7 and 8. If a particular sound pulse is detected by sensor 600S before it is detected by sensor 600N, as shown in FIG. 7, a correction is made in the Y servo loop to move the beam northward until it returns to the center of the aperture 221. If the same pulse were detected by sensor 600N before sensor 600S, a correction would be made to move the beam southward. Similarly with reference to FIG. 8, as a pulse will be detected by sensor 600W before it is detected by sensor 600E, a correction will be made in the X servo loop to move the beam eastward.

To assist in the timing discrimination, use can be made of the timing reference SYNC, for example by using a reference pulse to start timers responsive to the arrival of acoustic pulses. Depending on the frequencies present in the acoustic signals, phase as well as simple timing may be compared.

As pulses arrive at 50 kHz and each set of acoustic pulse potentially represents a complete measurement of alignment error, measurements can in principle be used for feedback control pulse-by-pulse.

Depending on detail of the apparatus and its environment, the only acoustic signals arriving at the sensors 600 may be the signature of EUV radiation hitting the wall of cone 501, which is what is to be measured. In other examples, it may be necessary to separate the wanted signals from acoustic signals originating from other sources.

For discriminating acoustic signals representing EUV radiation striking the cone 501 in the vicinity of the aperture for other acoustic signals, various measures can be applied in the pre-processors 606 and/or the analyzer 608. Where the frequency of EUV generating pulses is 50 kHz, for example, a phase-locked loop tuned to that frequency can be synchronized to the source pulse frequency, and unwanted signals filtered or gated out. In a simple, filter-based embodiment, measurements can be smoothed over several pulses to improve signal to noise ratios (SNR), while still providing a more rapid feedback response than known techniques.

Alternatively or in addition, time gating can be used on each pulse. Based on the timing signal SYNC, modules 604 and 500 ‘know’ when to expect acoustic signals generated by the particular acoustic energy source 610. Acoustic “noise”, such as signals generated by EUV light or IR laser energy that hits the walls of the radiation source apparatus at positions away from cone 501, can be gated out and ignored by the plasma control function.

The form of the sensors may also be such that they are sensitive to sounds from one direction more than another. An additional option for improving selectivity of the method for sound waves produced at a specific Z-position in the material surrounding the beam is therefore to align the sensitive direction of the acoustic sensor with the propagation direction of the sound wave that needs to be detected. With piezoelectric transducers, for example, the highest sensitivity is generally when an acoustic wavefront is parallel to the sensor surface.

FIG. 9 shows a further example of a monitoring and control apparatus, in which control of plasma position in three directions, X, Y and Z is achieved using signals the acoustic sensors 600N etc. Error signals ER(X), ER(Y) and ER(Z) and control signals CT(X), CT(Y) and CT(Z) are output by modules 604 and 500 respectively, to implement three parallel servo loops. Control of plasma 210 in the Z direction is effectively a focus control for the optical system comprising plasma 221, collector CO and aperture 221. (Of course, other types of sensors and processing may be provided in addition.) Rather than detecting when the beam is asymmetrical in X or Y, the sensor signals are analyzed in a different way, to discriminate between different focus conditions and to steer the beam to a focused condition. Depending on details of the optical system, the shape of the beam 602 may be different, behind and in front of the virtual source point IF. The size of the beam may also differ, of course. The timing signal SYNC is omitted from FIG. 9 only to reduce clutter, and can still be provided if desired.

In addition to the provision of this third control loop for focus, a sequencer 612 is provided, to enable measurement of the beam alignment and/or focus when it is not otherwise impinging on the cone 501. Sequencer 612 may be a separate module in hardware or software, or may be integrated in the hardware or software of analyzer 604 and/or control module 500. With the beam perfectly focused and centered, there may be so little EUV radiation impinging on the cone 501, that no acoustic signals can be derived on which to base control actions. For the purpose of damage avoidance, this lack of signals is not a problem at all. For other purposes, however, it may still be desired to obtain measurements of the location of the virtual source point IF in X, Y and/or Z directions.

In order to use the acoustic sensors 600N etc. for such measurements, sequencer 612 the apparatus can be programmed to introduce deliberate perturbations or offsets OF(X), OF(Y) and OF(Z), to induce variations in the error signals ER(X), ER(Y), ER(Z), and so gauge the position of the virtual source point. In the schematic diagram of FIG. 9, sequencer outputs the offsets, receives measurements from module 604 and generates datum signals D(X), D(Y) and D(Z) according to the acoustic signals observed at each offsets. Desirably, during stepping or scanning through these the EUV source is operated at lower energy and/or duty cycle to mitigate the risk of destroying the cone 501. In practice, the function of sequence 612 can be incorporated in control module 500 or module 604 by suitable programming. The offsets can be triggered frequently or infrequently, exploiting intervals between exposures. By stepping or scanning through a series of offset positions, the position of best alignment can be plotted.

Where perturbations (offsets) are introduced in two or more directions (X, Y, Z), they may be introduced in a single sequence which combines offsets in two or three dimensions, or each dimension may be tested by a separate sequence. The latter solution will be appropriate, for example, where the position of the virtual source point IF in one dimension is more volatile than in another. The offset sequence can then be performed more regularly for the one than the other.

The number of sensors in the example is four, but any suitable number may be chosen. Three or more sensors at spaced angular positions can resolve angular position of the acoustic energy source 610. Sensing at four quadrant positions may improve accuracy, and simplify processing if the control task is handled with reference to orthogonal X and Y axes as described above. The sensors need not be positioned in the axial (Z) direction at exactly the narrowest aperture in the IF cone 501. Depending on the geometry and the intensity of the beam and the cone, it may be useful to sense at a distance from the aperture. It may be useful to provide sensors at a range of axial positions, for better accuracy and/or for detecting additional anomalous conditions. Since the photoacoustic effect depends on rapid heating, it is to be expected that the acoustic signals will be strongest near the virtual source location IF, where the energy density of the beam is greatest. A greater number of sensors can also be deployed to provide redundancy in case any of them fails, and/or to improve SNR by averaging.

The alarm signal AL may be used to apply safety interventions, including shutting down the radiation source, in the even that errors in beam alignment or focus cannot be rectified within a time period. The alarm and shutdown behaviors may be defined with reference to different thresholds, so that minor deviations are addressed by the control module 500 if possible, and alarm/shutdown conditions apply if certain thresholds of error size and duration are exceeded. The same apparatus can thus function for fine control of the source in normal operation, and for rapid detection and prevention of damage in fault conditions. Use of acoustic sensors does not exclude the provision of additional thermal sensors, or optical sensors of the type used in the prior example. Thermal sensors will have a slower response than the acoustic sensor, but will be useful for example in controlling cooling mechanisms in the walls of the apparatus near the aperture.

In order for the photoacoustic effect to serve as a detector for the EUV radiation, the radiation should be variable, which for pulsed sources is inherently the case. For non-pulsed sources, such as synchrotron sources, pulsing or other variations can be introduced deliberately to enable photoacoustic sensing. This could be achieved for example by control of the source, or by introducing a chopping blade or wheel into the beam path intermittently. It is unlikely that such operation will be compatible with real-time monitoring during exposures, but other benefits of photoacoustic sensing will still be obtained. Potentially one could consider chopping only the peripheral portions of the beam, however, so as to allow measurement simultaneous with lithographic exposures.

Whatever variations and modifications are used in a particular example, it will be appreciated that the use of acoustic sensors enables the designer of the EUV source and the larger EUV optical lithography apparatus to obtain several benefits. The sensors can be placed outside the critical source environment, avoiding the expensive precautions desired to ensure vacuum, H₂ or EUV compatibility. The sensors can be smaller, faster, cheaper and more accurate than known solutions. They are not limited to any particular form of source, though pulsed sources are particularly easy to monitor. They are also easier to maintain or swap. The accuracy of monitoring and measurement resolves the machine damage issue, potentially eliminating also the alignment sensors in illuminator IL. This allows source module as a self-contained “plug and play” module that can control its own performance.

While specific embodiments of the invention have been described above, it will be appreciated that the invention may be practiced otherwise than as described. The behavior of the apparatus may be defined in large part by a computer program containing one or more sequences of machine-readable instructions for implementing certain steps of a method as disclosed above, or a data storage medium (e.g. semiconductor memory, magnetic or optical disk) having such a computer program stored therein. The descriptions above are intended to be illustrative, not limiting. Thus it will be apparent to one skilled in the art that modifications may be made to the invention as described without departing from the scope of the claims set out below.

What is claimed is:

1. A radiation source apparatus comprising:
a radiation source configured to emit electromagnetic radiation at an EUV wavelength;
a radiation collector configured to receive the emitted radiation and form a beam of EUV radiation focused at a virtual source point;
an exit aperture positioned in the vicinity of the virtual source point to deliver the EUV radiation from an internal environment of the radiation source apparatus to an optical system where the EUV radiation is to be used;
an acoustic sensor coupled to material located adjacent the radiation beam at or near the exit aperture; and
a processor configured to process signals received from the acoustic sensor so as to detect when part of the radiation beam impinges on the material.

2. An apparatus as claimed in claim 1, wherein the acoustic sensor is one of a plurality of acoustic sensors coupled to the material at different angular positions around the beam, and wherein the processor is configured to analyze signals from the plurality of acoustic sensors together, so as to discriminate between acoustic signals originating at different angular positions in the material.

3. An apparatus as claimed in claim 2, wherein the plurality of acoustic sensors includes at least three acoustic sensors coupled to the material at different angular positions around the beam, and wherein the processor is configured to process signals from the plurality of acoustic sensors and to discriminate the positions in at least two dimensions transverse to a nominal axis of the beam.

4. An apparatus as claimed in claim 1, further comprising a controller configured to control the radiation source by reference to received sensor signals so as to maintain the virtual source point within the exit aperture, wherein the sensor signals used by the controller include signals derived by the processor from the acoustic sensor.

5. An apparatus as claimed in claim 4, wherein the controller is arranged to control the position of the virtual source point in two dimensions transverse to an axis of the beam.

6. An apparatus as claimed in claim 4, wherein the controller is arranged to control the position of the source in a focus direction parallel to an optical axis of the collector.

7. An apparatus as claimed in claim 1, further comprising a sequencer arranged to introduce a sequence of known offsets into the position of the virtual source point, and a processor for analyzing signals received from the sensor or the plurality of sensors for each offset in the sequence, and to derive from the resulting sequence of analyzed signals additional characteristics of the radiation beam.

8. An apparatus as claimed in claim 7, wherein the apparatus is arranged to operate the radiation source at a reduced power level while the sequence of offsets is applied.

9. An apparatus as claimed in claim 1, wherein the radiation source comprises a plasma generator configured to apply pulses of energy to a fuel material so as to generate a plasma which emits pulses of electromagnetic radiation at the EUV wavelength.

10. A method of controlling a radiation source apparatus, the method comprising:
emitting electromagnetic radiation at an EUV wavelength with a radiation source;
receiving the emitted radiation and forming a beam of EUV radiation focused at a virtual source point with a radiation collector;
delivering the EUV radiation from an internal environment of the radiation source apparatus to an optical system where the EUV radiation is to be used through an exit aperture positioned in the vicinity of the virtual source point;
detecting an acoustic signal in material located adjacent the radiation beam at or near the exit aperture; and
processing the acoustic signal so as to detect when part of the radiation beam impinges on the material.

11. A method as claimed in claim 10, wherein a plurality acoustic signals are detected separately at different angular positions around the beam, and wherein the plurality of acoustic signals are processed together, so as to discriminate between acoustic signals originating at different angular positions in the material.

12. A method as claimed in claim 10, further comprising:
controlling the radiation source by reference to observed conditions so as to maintain the virtual source point within the exit aperture, wherein the observed conditions observed by the controller include the acoustic signals.

13. A method as claimed in claim 12, wherein the position of the virtual source point is controlled in at least two dimensions transverse to an axis of the beam.

14. A method as claimed in claim 12, wherein the position of the virtual source point is controlled in a focus direction parallel to an optical axis of the collector.

15. A method as claimed in any of claims 10, further comprising:
introducing a sequence of known offsets into the position of the virtual source point; and
analyzing acoustic signals detected in the material for each offset in the sequence, to derive additional characteristics of the radiation beam.

16. A method as claimed in claim 15, wherein the radiation source is operated at reduced power while the offsets are applied.

17. A lithographic apparatus comprising:
a radiation source apparatus comprising
a radiation source configured to emit electromagnetic radiation at an EUV wavelength,
a radiation collector configured to receive the emitted radiation and form a beam of EUV radiation focused at a virtual source point,
an exit aperture positioned in the vicinity of the virtual source point to deliver the EUV radiation from an internal environment of the radiation source apparatus to an optical system where the EUV radiation is to be used,
an acoustic sensor coupled to material located adjacent the radiation beam at or near the exit aperture, and
a processor configured to process signals received from the acoustic sensor so as to detect when part of the radiation beam impinges on the material;
an illuminator module configured to receive the beam of EUV radiation from the exit aperture of the radiation source apparatus and to condition the beam of EUV radiation;
a support configured to support a patterning device, the patterning device being configured to be illuminated by the beam of EUV radiation; and
a projection system configured to produce an image of the illuminated patterning device on a substrate, in order to transfer a pattern from the patterning device to the substrate by EUV lithography.

18. A method of manufacturing a device, comprising:
emitting electromagnetic radiation at an EUV wavelength with a radiation source;
receiving the emitted radiation and forming a beam of EUV radiation focused at a virtual source point with a radiation collector;
delivering the EUV radiation from an internal environment of the radiation source apparatus to an optical system where the EUV radiation is to be used through an exit aperture positioned in the vicinity of the virtual source point;
detecting an acoustic signal in material located adjacent the radiation beam at or near the exit aperture;
processing the acoustic signal so as to detect when part of the radiation beam impinges on the material;
delivering the EUV radiation with the optical system to a patterning device;
projecting an image of the patterning device onto a substrate.
